(19) United States
(12) Patent Application Publication
(10) Pub. No.: US 2004/0048056 A1
(43) Pub. Date: Mar. 11, 2004

(54) Injection-molded product, mold for injection molding, and injection molding method

(75) Inventors: Yasushi Mizuta, Ibaraki (JP); Takashi Arai, Ibaraki (JP); Shuji Inoue, Ibaraki (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaihsa, Tokyo (JP)

(21) Appl. No.: 10/653,927

(22) Filed: Sep. 4, 2003

(30) Foreign Application Priority Data
Sep. 9, 2002 (JP) 2002-263136

(51) Int. Cl. B29C 45/03

(52) U.S. Cl. 428/304.4; 264/41; 264/328.1; 425/542

(57) ABSTRACT

This invention aims at preventing a peeling phenomenon occurring on the surface of a foamed product. In order to achieve this object, an injection-molded product formed in accordance with injection molding by mixing a foaming agent in a molding resin material, is formed by molding using a mold having a heat insulating material on a surface of its cavity forward in a moving direction of a portion where the molding resin material molten and injected for forming the molded product has an injection speed of at least 1.5 m/sec to 2,000 m/sec in the cavity of the mold.

### FIELD OF THE INVENTION

The present invention relates to a technique for preventing a peeling phenomenon occurring on the surface of a foamed product.

### BACKGROUND OF THE INVENTION

Injection foam molding is a technique effective for reducing the weight and material of an injection-molded product, but a phenomenon that a very thin layer on the surface of the molded product peels occurs often. A molded product in which surface peeling occurs not has a bad appearance but also is likely cause a change in its size when a peeling layer drops as the molded product is brought into slidable contact with other components with which it is to be combined. In a printer machine or the like, a peeling layer that has dropped due to contact with printing paper during paper feeding or delivery or frictional resistance occurring when stirring the toner or ink may mix in the toner or ink to degrade the printing quality, thus causing a bad influence on the product function. However, no disclosure is currently found in any references or official gazettes concerning a technique for preventing the peeling phenomenon.

According to the experiments and observations by the present inventors, the degree of the peeling phenomenon depends on the injection speed of the resin material injected into the mold. The faster the injection speed, the more likely a peeling phenomenon tends to occur, and the larger the peeling range. Furthermore, the surface state of a peeling portion resembles closely a whitening phenomenon found on, e.g., the surface of a plate-like resin object when a bending load is applied to it. Therefore, it is estimated that the peeling phenomenon occurs when a resin material is injected into a mold, because a surface layer which is initially formed by fountain flow and in which solidification progresses is stretched by the flow of a continuously injected-inner layer and the uppermost surface layer having the fastest solidification speed separates. More specifically, this is a phenomenon occurring at that portion of the resin material where the flow speed is high, and is characteristic in that it occurs forward in the flowing direction of a portion represented by a gate of a molded product, where the flow path of the resin has a small sectional area.

Hence, although the degree of occurrence of the peeling phenomenon may be improved when the injection speed of the resin material is decreased to relatively decrease the flowing speed, whether the peeling phenomenon can be solved or not depends on the change in sectional area of the resin flow path. In foam molding, particularly when the thickness of the molded product is about 3 mm or less, if the injection speed of the resin material decreases, the foaming state in the inner layer is considerably interfered with. Then, advantages such as weight reduction which should be obtained when injection foam molding is employed cannot be attained.

Japanese Patent Laid-Open No.8-174561 discloses a heat insulating layer coated mold constituted by coating, with a heat insulating layer with a thickness of 0.01 mm to 2 mm, the mold wall surface constituting the mold cavity of a main mold composed of a metal. The heat insulating layer is composed of a thermosetting resin set material with a glass transition temperature of 180° C. or more and a breaking extension of 3.5% or more.

### SUMMARY OF THE INVENTION

The present invention has been made to solve this problem, and has as its object to prevent a peeling phenomenon occurring on the surface of an injection-foamed product.

In order to solve the above problem and to achieve the above object, according to the first aspect of the present invention, there is provided an injection-molded product formed in accordance with injection molding by mixing a foaming agent in a molding resin material, wherein the injection-molded product is formed by molding using a mold having a heat insulating material on a surface of a cavity thereof forward in a moving direction of a portion where the molding resin material molten and injected for forming the molded product has an injection speed of at least 1.5 m/sec to 2,000 m/sec in the cavity of the mold.

According to the second aspect of the present invention, there is provided a mold for injection molding, for forming, by molding, an injection-molded product by mixing a foaming agent in a molding resin material and injecting the foaming-agent-mixed molding resin material, wherein the mold for injection molding has a heat insulating material on a surface of a cavity thereof forward in a moving direction of a portion where the molding resin material molten and injected for forming the molded product has an injection speed of at least 1.5 m/sec to 2,000 m/sec in the cavity of the mold.

According to the third aspect of the present invention, there is provided an injection molding method of forming, by molding, an injection-molded product by mixing a foaming agent in a molding resin material and injecting the foaming-agent-mixed molding resin material, wherein molding is performed by using a mold having a heat insulating material on a surface of a cavity thereof forward in a moving direction of a portion where the molding resin material molten and injected for forming the molded product has an injection speed of at least 1.5 m/sec to 2,000 m/sec in the cavity of the mold.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing an example of a foamed product obtained when a heat insulating material with a thickness of 0.15 mm is formed on the surface of a mold cavity;

FIG. 2 is a view showing an example of a foamed product obtained when a heat insulating material with a thickness of 0.07 mm is formed on the surface of a mold cavity;

FIG. 3 is a view showing an example of a conventional foamed product; and

FIG. 4 is a table showing the molding results of the embodiment of the present invention and comparative examples.

### DETAILED DESCRIPTION OF THE PREFERRED EMBODIMENTS

A preferred embodiment of the present invention will be described.

According to this embodiment, a foamed product as a 200 mm (length)×150 mm (width)×10 mm (height) box with a thickness of 2 mm was molded by physical foaming of a molding resin material impregnated with carbon dioxide gas by using a mold in which one gate was arranged in accordance with the hot-runner valve gate system. The injection speed, obtained by calculation from molding conditions for this molding and from the specifications of the molding machine and mold, with which the molten resin material passed through the gate was about 180 m/sec.

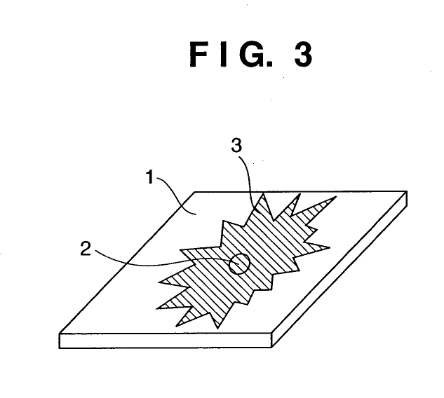

FIG. 3 shows an example of a foamed product obtained without according to the present invention. On the surface of a foamed product 1, a radial region having a central gate 2 as the center has a portion 3 with a color different from the surrounding portion. This portion 3 can peel off easily.

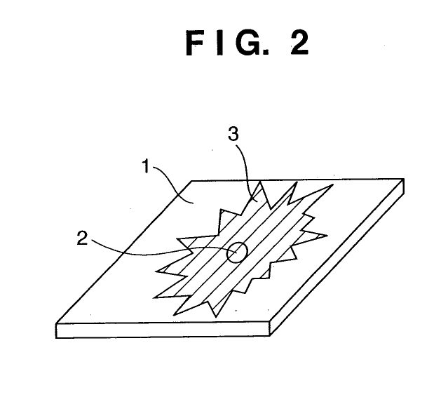

FIG. 2 shows a foamed product according to one embodiment of the present invention, which is obtained by forming a heat insulating material with a thickness of 0.07 mm on the surface of a mold cavity. When compared to the foamed product obtained without according to the present invention, in the foamed product of FIG. 2, the degree of color change of a portion 3 with a color different from the surrounding portion in a radial region having a center gate 2 as the center is small.

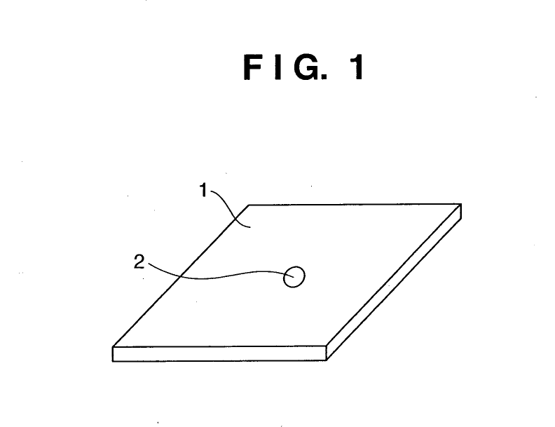

FIG. 1 shows a foamed product according to one embodiment of the present invention, which is obtained by forming a heat insulating material with a thickness of 0.15 mm on the surface of a mold cavity. In this foamed product, no portion having a color different from the surrounding portion in a radial region having a center gate 2 as the center is found.

To form the heat insulating layer, a vacuum vapor deposition polyimide film manufactured by Shinku Yakin K. K. was used. The heat insulating material was formed on the cavity surface forward in the moving direction of a portion where a molding material, molten and injected when forming a foamed product, had an injection speed of 1.5 m/sec to 2,000 m/sec in the mold cavity.

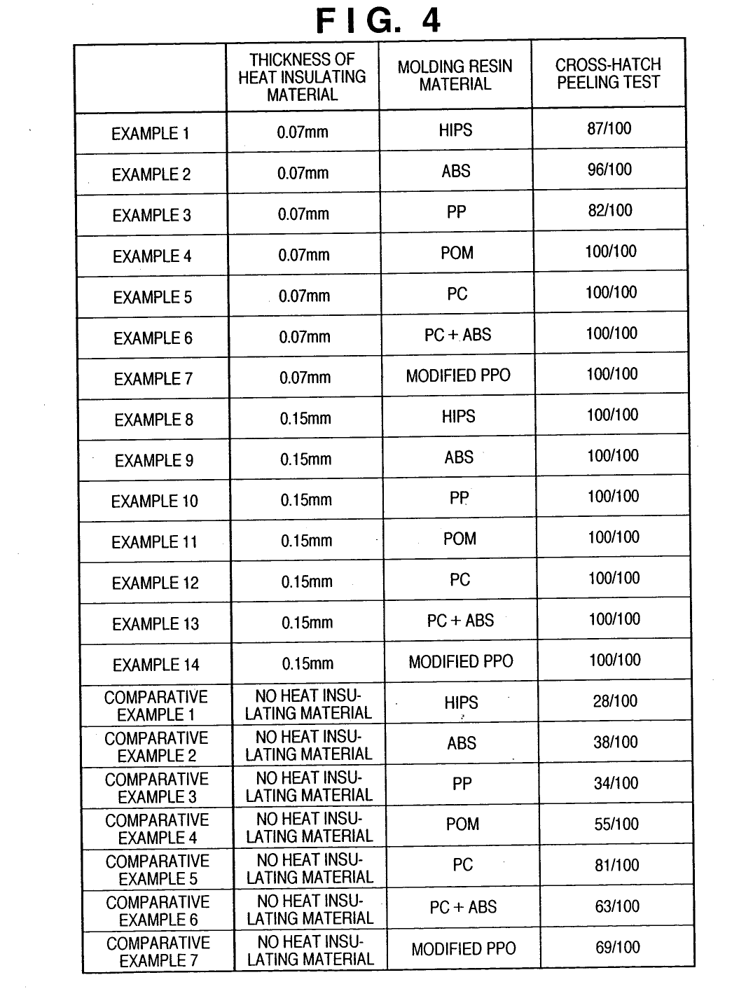

Various types of molding resin materials were used. Three types of foamed products having different thickness in heat insulating material or having no heat insulating materials were formed using each material. To evaluate the peeling states of these foamed products, cross-hatch peeling test based on JIS K5400 was performed for the portion 3 with the color different from the surrounding portion in the radial region with the center gate 2 as the center. If the foamed product had no portion with a color different from the surrounding portion, the test was performed for a portion identical to that of the foamed product with a color-changed portion. FIG. 4 shows the result of the test.

More specifically, using a cutter knife, 1-mm square cross-hatch incisions were formed on the surface of a foamed product to be evaluated. Adhesive tape pieces based on JIS Z1522 and having an adhesion force of 2.94 N/10 mm or more were adhered to the surface with incisions, and were peeled. The number of adhesive tape pieces that did not peel in 100 parts of 1 mm square grids was evaluated.

According to the experimental result shown in FIG. 4, in this embodiment, the peeling strength on the surface of the foamed product is increased, although it may differ depending on the molding resin material to be used.

In particular, according to this embodiment, when a heat insulating material having a thickness of about 0.07 mm to 0.15 mm was formed on the cavity surface of the mold, the peeling strength of the surface of the foamed product increased.

As has been described above, according to this embodiment, the peeling phenomenon occurring on the surface of a foamed product can be prevent without interfering with advantages, e.g., weight reduction, obtained when injection foam molding is employed.

As many apparently widely different embodiments of the present invention can be made without departing from the spirit and scope thereof, it is to be understood that the invention is not limited to the specific embodiments thereof except as defined in the appended claims.

What is claimed is:

1. An injection-molded product formed in accordance with injection molding by mixing a foaming agent in a molding resin material, wherein
the injection-molded product is formed by molding using a mold having a heat insulating material on a surface of a cavity thereof forward in a moving direction of a portion where the molding resin material molten and injected for forming the molded product has an injection speed of at least 1.5 m/sec to 2,000 m/sec in the cavity of the mold.

2. The product according to claim 1, characterized by being molded by using a mold in which the heat insulating material is formed around a gate on the surface of the cavity of the mold.

3. The product according to claim 1, characterized by being molded by using a mold in which the heat insulating material has a thickness of 0.07 mm to 0.15 mm.

4. A mold for injection molding, for forming, by molding, an injection-molded product by mixing a foaming agent in a molding resin material and injecting the foaming-agent-mixed molding resin material, wherein
the mold for injection molding has a heat insulating material on a surface of a cavity thereof forward in a moving direction of a portion where the molding resin material molten and injected for forming the molded product has an injection speed of at least 1.5 m/sec to 2,000 m/sec in the cavity of the mold.

5. The mold according to claim 4, wherein the heat insulating layer is formed around a gate on the surface of the cavity of the mold.

6. The mold according to claim 4, wherein the heat insulating material has a thickness of 0.07 mm to 0.15 mm.

7. An injection molding method of forming, by molding, an injection-molded product by mixing a foaming agent in a molding resin material and injecting the foaming-agent-mixed molding resin material, wherein
molding is performed by using a mold having a heat insulating material on a surface of a cavity thereof forward in a moving direction of a portion where the molding resin material molten and injected for forming the molded product has an injection speed of at least 1.5 m/sec to 2,000 m/sec in the cavity of the mold.

8. The method according to claim 7,.wherein molding is performed by using a mold in which the heat insulating layer is formed around a gate on the surface of the cavity of the mold.

9. The method according to claim 7, wherein molding is performed by using a mold in which the heat insulating material has a thickness of 0.07 mm to 0.15 mm.
